(19) United States
(12) Patent Application Publication
(10) Pub. No.: US 2020/0282362 A1
(43) Pub. Date: Sep. 10, 2020

(54) REVERSE OSMOSIS MEMBRANE SUPPORT MATERIAL AND PREPARATION METHOD THEREOF

(71) Applicant: TIANJIN POLYTECHNIC UNIVERSITY, Xinqing District (CN)

(72) Inventors: Xupin ZHUANG, Xiqing District (CN); Bowen CHENG, Xiqing District (CN); Weimin KANG, Xiqing District (CN); Gaokai ZHANG, Xiqing District (CN); Xianlin XU, Xiqing District (CN); Lei SHI, Xiqing District (CN)

(21) Appl. No.: 16/681,203

(22) Filed: Nov. 12, 2019

(30) Foreign Application Priority Data
Mar. 6, 2019 (CN) 201910167712.5

(51) Int. Cl. B01D 69/10; B01D 61/02; D04H 13/00; D21H 13/24; D21H 15/10

(52) U.S. Cl. CPC B01D 69/10; B01D 61/025; D21H 15/10; D21H 13/24; D04H 13/00

(57) ABSTRACT

The present invention relates to the technical field of filtering materials and provides a reverse osmosis membrane support material. The support material is obtained by hot pressing treatment of a surface layer, a middle layer and a bottom layer which are sequentially disposed from top to bottom. The surface layer and the bottom layer are each a spunbond non-woven fabric layer made of thermoplastic polymer spunbonded fibers, and the middle layer is a polymer nanofiber membrane. In accordance with the invention, the comprehensive mechanical strength of the reverse osmosis membrane support material is improved, and the overall anti-leakage performance is enhanced. A spunbond technology and a nanofiber preparation technology are combined organically, and the method is simple and controllable. The support material can be produced in batches.

This application claims priority to Chinese application number 201910167712.5, filed Mar. 6, 2019, with a title of REVERSE OSMOSIS MEMBRANE SUPPORT MATERIAL AND PREPARATION METHOD THEREOF. The above-mentioned patent application is incorporated herein by reference in its entirety.

### TECHNICAL FIELD

The present invention belongs to the technical field of filtration materials, and in particular relates to a reverse osmosis membrane support material and a preparation method thereof.

### BACKGROUND

A reverse osmosis membrane is an artificial semi-permeable membrane that is made of a simulated biological semi-permeable membrane and has certain characteristics, and is a core component of a reverse osmosis technology. Reverse osmosis can effectively retain all dissolved salts and organic matter with a molecular weight greater than 100, so dissolved salts, colloids, microorganisms, organic matter, and the like in water can be effectively removed, while water molecules are allowed to pass. The quality of water obtained by a reverse osmosis system is good, and the reverse osmosis system has the advantages of having low energy consumption and no pollution and being simple and convenient to operate.

Since a membrane is very brittle and has poor strength, researchers often use a composite structure in the preparation of a reverse osmosis membrane, such as a reverse osmosis membrane composed of a desalting separation layer, a polysulfone support layer and a non-woven support layer (See FIG. 1), where the desalting separation layer is used for desalting to effectively separate a solute in a solution. The polysulfone support layer ensures that inlet water can flow between membrane sheets and enhances a hydrodynamic state of the inlet water. The non-woven fabric support layer is used for supporting the whole reverse osmosis membrane, providing strength and improving overall mechanical properties and compressive properties. The reverse osmosis membrane should have the following characteristics as a whole: the reverse osmosis membrane has an efficient salt removing rate at a high flow rate and high mechanical strength and service life; can function under lower operating pressure, can resist chemical or biochemical effects and is subjected to small influence of factors such as pH value and temperature; sources of raw material for producing the membrane are easy, and the reverse osmosis membrane is simple and convenient to process and low in cost.

In order to meet the above requirements, in the reverse osmosis membrane, the preparation of the non-woven support layer is particularly critical. The non-woven support layer prepared by using an existing preparing method in the prior art also has various problems. For example, in a support layer prepared by a spunbond method, although a fiber web formed by continuous fibers has high strength and does not fluff easily, the thickness of the support layer becomes large due to the too long fiber and large surface pore diameter, which cannot meet the requirements for the thinning of the reverse osmosis membrane. In addition, the non-woven support layer prepared by the spunbond method is also prone to serious leakage problems. When tape casting of a high-molecular polymer solution is performed, excessive permeation may occur in some places to cause strike-through, which pollutes a membrane-preparing device. In a wet-laid process, to obtain a material having good evenness, the ratio (L/D) of the fiber diameter (D) to the fiber length (L) should be controlled within a certain range, which requires to shorten the fiber length; however, when the fiber length is shortened, the strength of a non-woven fabric will be compromised, the fiber web surface will fluff, the smoothness will be lowered, and the fiber winding dispersibility is affected. Therefore, the performance of the support material prepared by the above method cannot meet the overall requirements for thinning and high functionality of the reverse osmosis membrane.

### SUMMARY

In view of this, an objective of the present invention is to provide a reverse osmosis membrane support material which is obtained by integral hot pressing of a surface layer, a middle layer and a bottom layer which are sequentially disposed from top to bottom. The reverse osmosis membrane support material is simple, convenient and easy to obtain, and has the characteristics of small thickness, good evenness and effective prevention of leakage of a polymer casting solution.

To achieve the above purpose, the present invention provides the following technical solutions.

The present invention provides a reverse osmosis membrane support material, where the reverse osmosis membrane support material is obtained by hot pressing treatment of a surface layer, a middle layer and a bottom layer which are sequentially disposed from top to bottom. The surface layer and the bottom layer are each a spunbond non-woven fabric layer. The spunbond non-woven fabric layer is made of thermoplastic polymer spunbonded fibers; and the middle layer is a polymer nanofiber membrane.

Preferably, the thermoplastic polymer includes one or more of polyester, polyamide, polylactic acid, polypropylene, polystyrene, polytetrafluoroethylene, polyphenylene sulfide, and cellulose acetate.

Preferably, a polymer in the polymer nanofiber membrane includes one or more of polyester, polysulfone, polyethersulfone, polyamide, polylactic acid, cellulose acetate, polytetrafluoroethylene and polyvinylidene fluoride.

Preferably, the support material has an apparent surface density of 0.75-0.95 g/cm³, a thickness of 35-80 μm, a surface layer smoothness of 20-30 s, and a gram weight of 40 g/m² to 70 g/m².

The present invention provides a preparation method of the above reverse osmosis membrane support material, including the following steps:

step (1): melt-spinning a thermoplastic polymer to obtain spunbonded fibers, and separating and laying the spunbonded fibers to obtain a spunbond non-woven fabric layer as a bottom layer;

step (2): spinning a polymer nanofiber membrane on the surface of the bottom layer in the step (1) by an electrospinning or solution blowing method as a middle layer;

step (3): melt-spinning a thermoplastic polymer to obtain spunbonded fibers, and separating and laying the spunbonded fibers on the surface of the middle layer to obtain a spunbond non-woven fabric layer as a surface layer, to obtain a layered material; and

step (4): performing hot pressing treatment on the layered material obtained in the step (3) to obtain a reverse osmosis membrane support material.

Preferably, the spunbonded fiber in the bottom layer in the step (1) has a diameter of 7-30 μm and a gram weight of 25-40 g/m²; and the spunbonded fiber in the surface layer in the step (3) has a diameter of 7-20 μm and a gram weight of 10-20 g/m².

Preferably, when the step (2) is performed by an electrospinning method, a concentration of a spinning solution for the electrospinning is 8-20 wt %, a voltage of the electrospinning is 5-30 kV, and a receiving distance is 5-25 cm.

Preferably, when the step (2) is performed by a solution blowing method, a concentration of a spinning solution for the solution blowing is 8-20 wt %, a drafting air pressure of the solution blowing is 0.2-0.6 MPa, and a receiving distance is 50-120 cm.

Preferably, the polymer nanofiber membrane in the step (2) has a gram weight of 2-10 g/m², and a nanofiber in the polymer nanofiber membrane has a diameter of 50-900 nm.

Preferably, a hot pressing temperature of the hot pressing treatment in the step (4) is lower than the melting point of the polymer nanofiber membrane of the middle layer by 20-60° C., and the pressure of the hot pressing is 500-750 N/cm.

Beneficial Effects:

The present invention provides a reverse osmosis membrane support material, which is obtained by hot pressing treatment of a surface layer, a middle layer and a bottom layer which are sequentially disposed from top to bottom. The surface layer and the bottom layer are each a spunbond non-woven fabric layer. The spunbond non-woven fabric layer is made of thermoplastic polymer spunbonded fibers, and the middle layer is a polymer nanofiber membrane. Sources of raw materials adopted by the present invention are wide and the cost is low. The present invention adopts a three-layer composite structure which includes the bottom layer providing main mechanical support, the middle layer for preventing permeation of a casting solution and the surface layer for stabilizing the middle layer and coordinating the overall performance of the support material. The three-layer composite structure not only improves the comprehensive mechanical strength of the reverse osmosis membrane support material, but also strengthens the overall impermeability and has good practicability.

The present invention adopts the polymer nanofiber membrane as the middle layer. A nanofiber of the middle layer is small and sandwiched between spunbonded fiber layers to play a role in regulating the pore size of a fiber web, and the pore size distribution is narrow, to form a membrane-shaped dense layer, which can effectively prevent leakage of a polymer solution. In addition, the surface layer is a spunbonded fiber layer, and the fiber is long, which can effectively overcome the shortcomings of fiber web fluffing, low smoothness and poor strength caused by the short fiber of the nanofiber middle layer. The present invention satisfies the requirement of preventing leakage of a polymer casting solution in the case of a thinner nanofiber membrane, and the support material formed after hot pressing treatment has a uniform pore size distribution.

Results of embodiments show that the reverse osmosis membrane support material provided by the present invention has an apparent surface density of 0.75-0.95 g/cm³, a thickness of 35-80 μm, a surface layer smoothness of 20-30 s, and a gram weight of 40 g/m² to 70 g/m². The reverse osmosis membrane support material can be produced in batches, and the product quality is stable and reliable.

A preparation method of a reverse osmosis membrane support material provided by the present invention combines a spunbond technology and a nanofiber preparation technology organically, and the method is simple and controllable. The support material can be produced in batches.

### BRIEF DESCRIPTION OF THE DRAWINGS

FIG. 1 is a schematic structural view of a reverse osmosis membrane taking polysulfone as a support layer;

FIG. 2 is a schematic structural view of a reverse osmosis membrane support material according to the present invention;

FIG. 3 is a schematic flow chart of preparing a polymer nanofiber membrane by a wet laying method according to the present invention; and

FIG. 4 is a flow diagram of the preparation method of the reverse osmosis membrane support material according to an embodiment of the present invention.

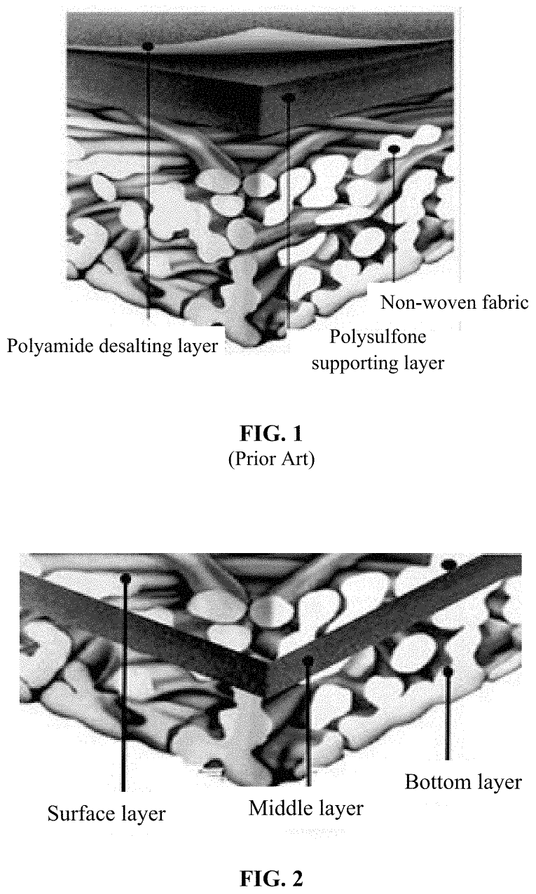

### DETAILED DESCRIPTION

The present invention provides a reverse osmosis membrane support material, which is obtained by hot pressing treatment of a surface layer, a middle layer and a bottom layer which are sequentially disposed from top to bottom. The surface layer and the bottom layer are each a spunbond non-woven fabric layer, and a schematic structural view is shown in FIG. 2. The spunbond non-woven fabric layer is made of thermoplastic polymer spunbonded fibers; and the middle layer is a polymer nanofiber membrane.

The surface layer and the bottom layer of the reverse osmosis membrane support material according to the present invention are each a spunbond non-woven fabric layer. The spunbond non-woven fabric layers are made of thermoplastic polymer spunbonded fibers. In the present invention, the surface layer and the bottom layer independently use a thermoplastic polymer preferably including one or more of polyester, polyamide, polylactic acid, polypropylene, polystyrene, polytetrafluoroethylene, polyphenylene sulfide, and cellulose acetate. In a specific embodiment of the present invention, one or more thermoplastic polymers may be used in combination. The present invention preferably uses a compound of thermoplastic polymers having eutectic points greater than 160° C. as a raw material for the surface layer and the bottom layer, and more preferably uses a compound of thermoplastic polymers having eutectic points of 180-300° C. In a specific embodiment of the present invention, for example, spun-grade PET and/or spun-grade PA6 may be used as a thermoplastic polymer material for the surface layer and the bottom layer. A purpose of the present invention to limit the eutectic point of the thermoplastic polymer is to select a thermoplastic polymer, which is advantageous for the subsequent hot pressing treatment forming. Those skilled in the art can carry out selection and combination according to the preferred thermoplastic polymer material provided by the present invention in combination with the control of the eutectic temperature. The source of the thermoplastic polymer of the present invention is not particularly limited.

The middle layer of the reverse osmosis membrane support material of the present invention is a polymer nanofiber membrane. The polymer used in the middle layer preferably includes one or more of polyester, polysulfone, polyethersulfone, polyamide, polylactic acid, cellulose acetate, polytetrafluoroethylene and polyvinylidene fluoride. In the present invention, the eutectic point of the polymer used in the middle layer is preferably slightly lower than the eutectic point of the thermoplastic polymer used in the surface layer and the bottom layer to ensure uniform heating of the three-layer composite structure during hot pressing treatment. This not only satisfies the bonding requirement for hot pressing integration, but also ensures the pore size distribution of the middle layer nanofiber membrane. The sources of the polymers of the present invention are not particularly limited.

In the present invention, the surface layer and the bottom layer are each a spunbond non-woven fabric layer, where a spunbonded fiber has a large diameter, is in the micron order, and mainly plays a supporting and protecting role. The middle layer is a polymer nanofiber membrane, and the nanofiber in the polymer nanofiber membrane has a relatively small diameter, is in the nanometer order and mainly plays a role of preventing leakage.

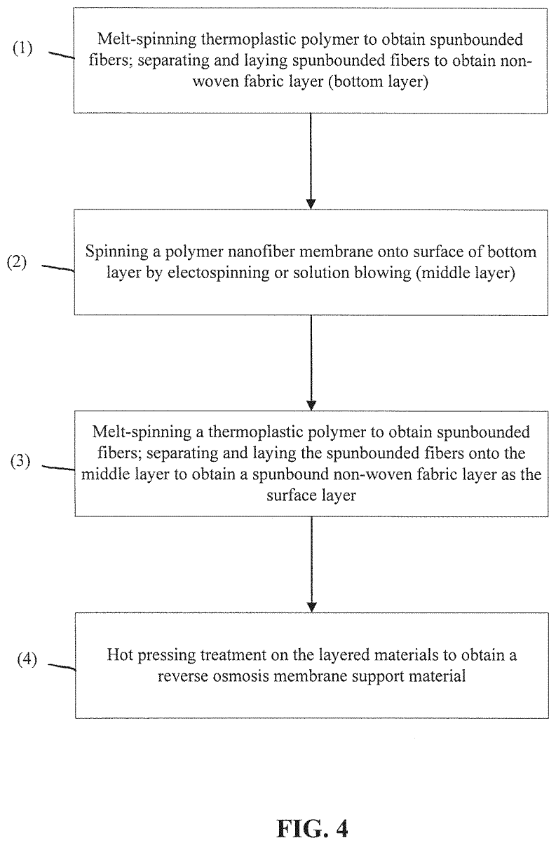

The present invention provides a preparation method of the reverse osmosis membrane support material according to the aforementioned technical solution, including the following steps (See e.g., FIG. 4):

Step (1): melt-spin a thermoplastic polymer to obtain spunbonded fibers, and separate and lay the spunbonded fibers to obtain a spunbond non-woven fabric layer as a bottom layer.

Step (2): spin a polymer nanofiber membrane on the surface of the bottom layer in the step (1) by an electrospinning or solution blowing method as a middle layer.

Step (3): melt-spin a thermoplastic polymer to obtain spunbonded fibers, and separate and lay the spunbonded fibers on the surface of the middle layer to obtain a spunbond non-woven fabric layer as a surface layer to obtain a layered material.

Step (4): perform hot pressing treatment on the layered material obtained in the step (3) to obtain a reverse osmosis membrane support material.

According to the present invention, a thermoplastic polymer is subjected to melt-spinning to obtain spunbonded fibers, and the spunbonded fibers are separated and laid to obtain a non-woven material layer as a bottom layer. In a specific embodiment of the present invention, a thermoplastic polymer is subjected to high temperature melt extrusion by using a spunbond method and then is spun, drafted and cooled to obtain spunbonded fibers. In the present invention, the diameter of the spunbonded fiber in the bottom layer is preferably 7-30 μm, more preferably 10-25 μm, and further preferably 18-22 μm.

In the present invention, the step of separating and laying specifically includes: first separating the prepared spunbonded fibers, laying the separate fibers on a web curtain to form a uniform fiber web, and eliminating static electricity of the fiber web. In the present invention, the separating method is preferably a gas flow, electrostatic or mechanical separating method.

In the present invention, the gram weight of the bottom layer is preferably 25-40 g/m², more preferably 37-42 g/m². The present invention uses the spunbond method to prepare the fibers and has fewer steps and a high production speed. The present invention has no special requirements for devices used for preparing the spunbonded fibers and used for separating and laying, and devices well known to those skilled in the art can be used.

After the bottom layer is obtained, according to the present invention, a polymer nanofiber membrane is spun on the surface of the bottom layer by an electrospinning or solution blowing method as a middle layer.

In the present invention, when the electrospinning method is adopted, a concentration of a spinning solution for the electrospinning is 8-20 wt %, more preferably 12-16 wt %; a voltage of the electrospinning is preferably 5-30 KV, more preferably 15-20 KV; a receiving distance is preferably 5-25 cm, more preferably 10-20 cm; and the electrospinning method is preferably a multi-needle electrospinning method. According to the present invention, through the control of electrospinning operation parameters, it can be ensured that the spinning process is stable, so that obtained polymer nanofibers have the same morphology, the formed middle layer has good evenness, and the pore distribution is reasonable, which is beneficial to maintaining an anti-leakage function of the middle layer.

In the present invention, when a solution blowing method is adopted, a concentration of a spinning solution for solution blowing is preferably 8-20 wt %, more preferably 12-16 wt %; a drafting air pressure of the solution blowing is preferably 0.2-0.6 MPa, more preferably 0.4-0.5 MPa, and a receiving distance is preferably 50-120 cm, more preferably 70-90 cm.

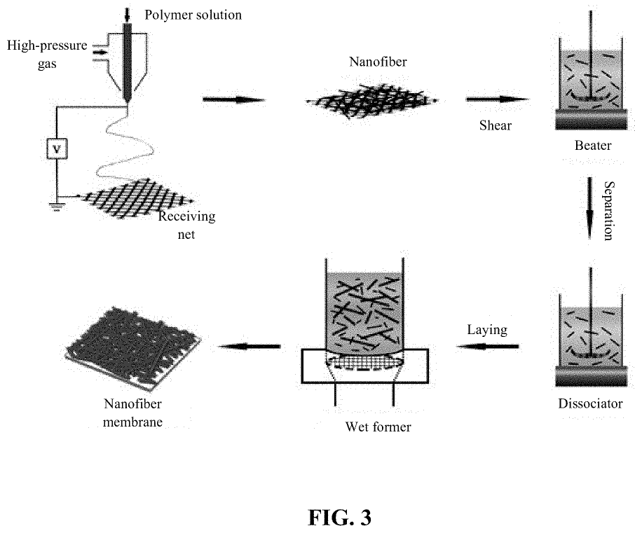

In a specific embodiment of the present invention, the above-mentioned electrospinning or solution blowing method may be used to directly form a middle layer on the surface of the bottom layer, or a large amount of polymer nanofibers may be prepared by using the electrospinning or solution blowing method first, and then the obtained polymer nanofibers are formed into a nanofiber membrane on the surface of the bottom layer by a wet laying method. The wet laying specifically includes: sequentially subjecting the nanofibers to shearing, beating, separation and laying treatment to obtain a nanofiber membrane, and the specific process is shown in FIG. 3.

In the present invention, a polymer nanofiber membrane of the middle layer preferably has a gram weight of 2-10 g/m², more preferably 5-7 g/m², and a diameter of a nanofiber in the polymer nanofiber membrane is 50-900 nm, more preferably 100-500 nm, further preferably 200-400 nm. In specific embodiments of the present invention, the diameter of the nanofiber obtained by spinning is controlled to be within the range of 50-900 nm, and the diameters of the nanofibers are not required to be uniform but are required to be in a range of values, and the nanofibers of different diameters fill each other to form a dense polymer nanofiber membrane having a uniform pore size.

After the middle layer is obtained, in the present invention, a thermoplastic polymer is subjected to melt-spinning to obtain spunbonded fibers, and the spunbonded fibers are separated and laid on the surface of the middle layer to obtain a spunbonded non-woven material as a surface layer. In the present invention, a specific operation method for melt-spinning and separating and laying in the step (3) is the same as the step (1), and details are not described herein again. In the present invention, a diameter of a spunbonded fiber in the surface layer is preferably 7-20 μm, more preferably 10-17 μm, further preferably 12-15 μm; and a gram weight of the surface layer is preferably 10-20 g/m², more preferably 13-17 g/m². In the present invention, the surface layer can further stabilize the middle layer and coordinate the overall performance of the support material.

After the surface layer is obtained, in the present invention, the obtained layered material is subjected to hot pressing treatment to obtain a reverse osmosis membrane support material. In the present invention, a hot pressing temperature of the hot pressing treatment is lower than the melting point of the polymer nanofiber membrane of the middle layer by 20-60° C. The present invention controls the hot pressing temperature to be lower than the melting point of the polymer nanofiber membrane, and the purpose is to ensure uniform heat transfer during hot pressing forming of the three-layer support material, satisfy the requirement of bonding each layer of material without affecting the pore size distribution inside the reverse osmosis membrane support material, and maintain the overall functionality. In the present invention, a pressure of the hot pressing treatment is preferably 500-750 N/cm, more preferably 700-750 N/cm; and a hot pressing treatment mode according to the present invention is preferably roller type hot rolling.

The reverse osmosis membrane support material according to the above technical solution of the present invention or the reverse osmosis membrane support material prepared by using the above preparation method has an apparent surface density of 0.75-0.95 g/cm³, a thickness of 35-80 μm, a surface layer smoothness of 20-30 s, and a gram weight of 40 g/m² to 70 g/m².

The reverse osmosis membrane support material and the preparation method thereof provided by the present invention are described in detail below with reference to the embodiments, but the embodiments cannot be understood as limiting the protection scope of the present invention.

### Embodiment 1

A preparation method of a reverse osmosis membrane support material according to one embodiment includes the following steps:

Step (1): spin spun-grade PET at 300° C. by a spunbond method, and obtain a spunbond non-woven fabric layer having an average fiber diameter of 21 μm and a gram weight of 35 g/m² by a separating and laying method as a bottom layer of a support material.

Step (2): use a multi-needle electrospinning technology to spin on the surface of the bottom layer to obtain a copolyester nanofiber membrane having a melting point of 220° C. as a middle layer. The multi-needle electrospinning conditions are as follows: high-voltage static electricity is 22 kV, a spinning solution concentration is 15%, a receiving distance is 22 cm, a gram weight of the nanofiber membrane is 6 g/m²; and a diameter of a nanofiber in the nanofiber membrane is 260-720 nm.

Step (3): spin spun-grade PET at 300° C. by a spunbond method, and obtain a spunbond non-woven fabric layer having an average fiber diameter of 18 μm and a gram weight of 15 g/m² by a separating and laying method as a surface layer of a support material.

Step (4): finally bond the three layers by roller type hot rolling at 180° C. and a pressure of 700 N/cm to obtain a three-layer composite reverse osmosis membrane support material.

The reverse osmosis membrane support material obtained in Embodiment 1 was subjected to basic performance measurement, and an apparent surface density was 0.84 g/cm³ and a thickness was 43 μm according to the standard GB/T 24328.2-2009; it was measured according to the standard GB/T 22881-2008 that the surface smoothness was 27 s and the gram weight was 60 g/m².

### Embodiment 2

A preparation method of a reverse osmosis membrane support material according to another embodiment includes the following steps:

Step (1): spin spun-grade PET at 300° C. by a spunbond method and obtain a spunbond non-woven fabric layer having an average fiber diameter of 21 μm and a gram weight of 35 g/m² by a separating and laying method as a bottom layer of a support body.

Step (2): use a multi-needle electrospinning technology to spin on the surface of the bottom layer to obtain a polyamide nanofiber membrane having a melting point of 230° C. as a middle layer. The electrospinning conditions are: high-voltage static electricity is 25 KV, a spinning solution concentration is 15%, a receiving distance is 22 cm, a gram weight of the nanofiber membrane is 8 g/m²; and a diameter of a nanofiber in the nanofiber membrane is 180-680 nm.

Step (3): spin spun-grade PET at 300° C. by a spunbond method, and obtain a spunbond non-woven fabric layer having an average fiber diameter of 15 μm and a gram weight of 20 g/m² by a separating and laying method as a surface layer of a support material.

Step (4): finally bond the three layers by roller type hot rolling at 180° C. and a pressure of 700 N/cm to obtain a three-layer composite reverse osmosis membrane support material.

The reverse osmosis membrane support material obtained in Embodiment 2 was subjected to basic performance measurement, and an apparent surface density was 0.79 g/cm³ and a thickness was 51 μm according to the standard GB/T 24328.2-2009; and it was measured according to the standard GB/T 22881-2008 that the surface smoothness was 26 s and the gram weight was 63 g/m².

### Embodiment 3

A preparation method of a reverse osmosis membrane support material according to a third embodiment includes the following steps:

Step (1): spin spun-grade PA6 at 286° C. by a spunbond method, and obtain a spunbonded non-woven material having an average fiber diameter of 23 μm and a gram weight of 37 g/m² by a separating and laying method as a bottom layer of a support material.

Step (2): use a multi-needle electrospinning technology to spin on the surface of the bottom layer to obtain a copolyester nanofiber membrane having a melting point of 220° C. as a middle layer. The multi-needle electrospinning conditions are as follows: high-voltage static electricity is 22 kV, a spinning solution concentration is 15%, a receiving distance is 22 cm, a gram weight of the nanofiber membrane is 12 g/m²; and a diameter of a nanofiber in the nanofiber membrane is 220-740 nm.

Step (3): spin spun-grade PA6 at 240° C. by a spunbond method, and obtain a spunbonded non-woven material having an average fiber diameter of 15 μm and a gram weight of 19 g/m² by a separating and laying method as a surface layer of a support material.

Step (4): finally bond the three layers by roller type hot rolling at 180° C. and a pressure of 700 N/cm to obtain a three-layer composite reverse osmosis membrane support material.

The reverse osmosis membrane support material obtained in Embodiment 3 was subjected to basic performance measurement, and an apparent surface density was 0.87 g/cm³ and a thickness was 40 μm according to the standard GB/T 24328.2-2009; and it was measured according to the standard GB/T 22881-2008 that the surface smoothness was 27 s and the gram weight was 67 g/m².

### Embodiment 4

A preparation method of a reverse osmosis membrane support material according to a fourth embodiment includes the following steps:

Step (1): spin spun-grade PA6 at 286° C. by a spunbond method, and obtain a spunbonded non-woven material having an average fiber diameter of 23 μm and a gram weight of 37 g/m² by a separating and laying method as a bottom layer of a support body.

Step (2): use a multi-needle electrospinning technology to spin on the surface of the bottom layer to obtain a polyamide nanofiber membrane having a melting point of 230° C. The electrospinning conditions are as follows: high-voltage static electricity is 25 KV, a spinning solution concentration is 15%, a receiving distance is 22 cm, a gram weight of the nanofiber membrane is 6 g/m²; and a diameter of a nanofiber in the nanofiber membrane is 210-700 nm.

Step (3): spin spun-grade PA6 at 240° C. by a spunbond method, and obtain a spunbonded non-woven material having an average fiber diameter of 14 μm and a gram weight of 15 g/m² by a separating and laying method as a surface layer of a support material.

Step (4): finally bond the three layers by roller type hot rolling at 180° C. and a pressure of 700 N/cm to obtain a three-layer composite reverse osmosis membrane support material.

The reverse osmosis membrane support material obtained in Embodiment 4 was subjected to basic performance measurement, and an apparent surface density was 0.83 g/cm³ and a thickness was 45 μm according to the standard GB/T 24328.2-2009; and it was measured according to the standard GB/T 22881-2008 that the surface smoothness was 27 s and the gram weight was 65 g/m².

### Embodiment 5

A preparation method of a reverse osmosis membrane support material according to a fifth embodiment adopts a solution blowing method to obtain a middle layer and includes the following steps:

Step (1): spin spun-grade PET at 300° C. by a spunbond method and obtain a spunbonded non-woven material having an average fiber diameter of 21 μm and a gram weight of 35 g/m² by a separating and laying method as a bottom layer of a support body.

Step (2): use a solution blowing technology to spin on the surface of the bottom layer to obtain a polyamide nanofiber membrane having a melting point of 230° C. as a middle layer. The solution blowing conditions are as follows: a spinning solution concentration is 15%, a drafting air pressure is 0.2 MPa, an advance speed is 20 ml/h, a box body temperature is 45° C., and an auxiliary voltage is 4 kV, a receiving distance is 70 cm, a gram weight of the nanofiber membrane is 6 g/m²; and a diameter of a nanofiber in the nanofiber membrane is 310-820 nm.

Step (3): mix spun-grade PET with spun-grade PA6 at a proportion of 1:1, spin the mixture at 300° C. by a spunbond method and obtain a spunbonded non-woven material having an average fiber diameter of 17 μm and a gram weight of 20 g/m² by a separating and laying method as a bottom layer of a support body.

Step (4): finally bond the three layers by roller type hot rolling at 180° C. and a pressure of 700 N/cm to obtain a three-layer composite reverse osmosis membrane support material.

The reverse osmosis membrane support material obtained in Embodiment 5 was subjected to basic performance measurement, and an apparent surface density was 0.81 g/cm³ and a thickness was 49 μm according to the standard GB/T 24328.2-2009; and it was measured according to the standard GB/T 22881-2008 that the surface smoothness was 25 s and the gram weight was 65 g/m².

### Embodiment 6

A preparation method of a reverse osmosis membrane support material according to a sixth embodiment adopts a wet laying method to obtain a middle layer and includes the following steps:

Step (1): spin spun-grade PET at 300° C. by a spunbond method and obtain a spunbonded non-woven material having an average fiber diameter of 21 μm and a gram weight of 35 g/m² by a separating and laying method as a bottom layer of a support body.

Step (2): obtain polyamide nanofibers with a melting point of 230° C. by using a solution blowing method, where the diameter is 330-900 nm; place the polyamide nanofibers in a beater for shearing, separating the polyamide nanofibers in a dissociator, and then obtain a polyamide nanofiber membrane on the bottom layer by using a wet laying method as a middle layer, where the nanofiber membrane obtained by wet laying has a gram weight of 12 g/m².

Step (3): spin spun-grade PET at 300° C. by a spunbond method and obtain a spunbonded non-woven material having an average fiber diameter of 18 μm and a gram weight of 20 g/m² by a separating and laying method as a surface layer of a support body.

Step (4): finally bond the three layers by roller type hot rolling at 180° C. and a pressure of 700 N/cm to obtain a three-layer composite reverse osmosis membrane support material.

The reverse osmosis membrane support material obtained in Embodiment 6 was subjected to basic performance measurement, and an apparent surface density was 0.88 g/cm³ and a thickness was 42 μm according to the standard GB/T 24328.2-2009; and it was measured according to the standard GB/T 22881-2008 that the surface smoothness was 29 s and the gram weight was 67 g/m².

As can be seen Embodiments 1 to 6, the reverse osmosis membrane support material obtained by a three-layer composite method according to the present invention includes the bottom layer providing main mechanical support, the middle layer for preventing permeation of a casting solution and the surface layer for stabilizing the middle layer and coordinating the overall performance of the support material. The present invention combines a spunbond technology and a nanofiber preparation technology, the method is simple and controllable, and the reverse osmosis membrane support material can be produced in batches. The comprehensive mechanical strength of the reverse osmosis membrane support material is improved, the overall impermeability is enhanced, and the thickness of the support material is effectively reduced.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A reverse osmosis membrane support material, comprising:
a surface layer of a spunbond non-woven fabric of thermoplastic polymer spunbonded fibers;
a middle layer of a polymer nanofiber membrane; and
a bottom layer of a spunbond non-woven fabric of thermoplastic polymer spunbonded fibers;
wherein the reverse osmosis membrane support material is obtained by hot pressing treatment of the surface layer, the middle layer and the bottom layer which are sequentially disposed from top to bottom, respectively.

2. The reverse osmosis membrane support material according to claim 1, wherein the thermoplastic polymer comprises one or more of polyester, polyamide, polylactic acid, polypropylene, polystyrene, polytetrafluoroethylene, polyphenylene sulfide, and cellulose acetate.

3. The reverse osmosis membrane support material according to claim 1, wherein a polymer in the polymer nanofiber membrane comprises one or more of polyester, polysulfone, polyethersulfone, polyamide, polylactic acid, cellulose acetate, polytetrafluoroethylene and polyvinylidene fluoride.

4. The reverse osmosis membrane support material according to claim 1, wherein the support material has an apparent surface density of 0.75-0.95 g/cm³, a thickness of 35-80 μm, a surface layer smoothness of 20-30 s, and a gram weight of 40 g/m² to 70 g/m².

5. A preparation method of the reverse osmosis membrane support material according to claim 1, comprising:
step (1): melt-spinning a thermoplastic polymer to obtain spunbonded fibers, and separating and laying the spunbonded fibers to obtain a spunbond non-woven fabric layer as a bottom layer;
step (2): spinning a polymer nanofiber membrane on the surface of the bottom layer in the step (1) by an electrospinning or solution blowing method as a middle layer;
step (3): melt-spinning a thermoplastic polymer to obtain spunbonded fibers, and separating and laying the spunbonded fibers on the surface of the middle layer to obtain a spunbond non-woven fabric layer as a surface layer, to obtain a layered material; and
step (4): performing hot pressing treatment on the layered material obtained in the step (3) to obtain a reverse osmosis membrane support material.

6. A preparation method of the reverse osmosis membrane support material according to claim 2, comprising:
step (1): melt-spinning a thermoplastic polymer to obtain spunbonded fibers, and separating and laying the spunbonded fibers to obtain a spunbond non-woven fabric layer as a bottom layer;
step (2): spinning a polymer nanofiber membrane on the surface of the bottom layer in the step (1) by an electrospinning or solution blowing method as a middle layer;
step (3): melt-spinning a thermoplastic polymer to obtain spunbonded fibers, and separating and laying the spunbonded fibers on the surface of the middle layer to obtain a spunbond non-woven fabric layer as a surface layer, to obtain a layered material; and
step (4): performing hot pressing treatment on the layered material obtained in the step (3) to obtain a reverse osmosis membrane support material.

7. A preparation method of the reverse osmosis membrane support material according to claim 3, comprising:
step (1): melt-spinning a thermoplastic polymer to obtain spunbonded fibers, and separating and laying the spunbonded fibers to obtain a spunbond non-woven fabric layer as a bottom layer;
step (2): spinning a polymer nanofiber membrane on the surface of the bottom layer in the step (1) by an electrospinning or solution blowing method as a middle layer;
step (3): melt-spinning a thermoplastic polymer to obtain spunbonded fibers, and separating and laying the spunbonded fibers on the surface of the middle layer to obtain a spunbond non-woven fabric layer as a surface layer, to obtain a layered material; and
step (4): performing hot pressing treatment on the layered material obtained in the step (3) to obtain a reverse osmosis membrane support material.

8. A preparation method of the reverse osmosis membrane support material according to claim 4, comprising:
step (1): melt-spinning a thermoplastic polymer to obtain spunbonded fibers, and separating and laying the spunbonded fibers to obtain a spunbond non-woven fabric layer as a bottom layer;
step (2): spinning a polymer nanofiber membrane on the surface of the bottom layer in step (1) by an electrospinning or solution blowing method as a middle layer;
step (3): melt-spinning a thermoplastic polymer to obtain spunbonded fibers, and separating and laying the spunbonded fibers on the surface of the middle layer to obtain a spunbond non-woven fabric layer as a surface layer, to obtain a layered material; and
step (4): performing hot pressing treatment on the layered material obtained in step (3) to obtain a reverse osmosis membrane support material.

9. The preparation method according to claim 5, wherein the spunbonded fiber in the bottom layer in step (1) has a diameter of 7-30 μm and a gram weight of 25-40 g/m²; and the spunbonded fiber in the surface layer in step (3) has a diameter of 7-20 μm and a gram weight of 10-20 g/m².

10. The preparation method according to claim 6, wherein the spunbonded fiber in the bottom layer in step (1) has a diameter of 7-30 μm and a gram weight of 25-40 g/m²; and the spunbonded fiber in the surface layer in step (3) has a diameter of 7-20 μm and a gram weight of 10-20 g/m².

11. The preparation method according to claim 7, wherein the spunbonded fiber in the bottom layer in step (1) has a diameter of 7-30 μm and a gram weight of 25-40 g/m²; and the spunbonded fiber in the surface layer in step (3) has a diameter of 7-20 μm and a gram weight of 10-20 g/m².

12. The preparation method according to claim 8, wherein the spunbonded fiber in the bottom layer in step (1) has a diameter of 7-30 μm and a gram weight of 25-40 g/m²; and the spunbonded fiber in the surface layer in step (3) has a diameter of 7-20 μm and a gram weight of 10-20 g/m².

13. The preparation method according to claim 5, wherein when step (2) is performed by an electrospinning method, a concentration of a spinning solution for the electrospinning is 8-20 wt %, a voltage of the electrospinning is 5-30 kV, and a receiving distance is 5-25 cm.

14. The preparation method according to claim 6, wherein when step (2) is performed by an electrospinning method, a concentration of a spinning solution for the electrospinning is 8-20 wt %, a voltage of the electrospinning is 5-30 kV, and a receiving distance is 5-25 cm.

15. The preparation method according to claim 7, wherein when step (2) is performed by an electrospinning method, a concentration of a spinning solution for the electrospinning is 8-20 wt %, a voltage of the electrospinning is 5-30 kV, and a receiving distance is 5-25 cm.

16. The preparation method according to claim 8, wherein when step (2) is performed by an electrospinning method, a concentration of a spinning solution for the electrospinning is 8-20 wt %, a voltage of the electrospinning is 5-30 kV, and a receiving distance is 5-25 cm.

17. The preparation method according to claim 5, wherein when step (2) is performed by a solution blowing method, a concentration of a spinning solution for the solution blowing is 8-20 wt %, a drafting air pressure of the solution blowing is 0.2-0.6 MPa, and a receiving distance is 50-120 cm.

18. The preparation method according to claim 6, wherein when step (2) is performed by a solution blowing method, a concentration of a spinning solution for the solution blowing is 8-20 wt %, a drafting air pressure of the solution blowing is 0.2-0.6 MPa, and a receiving distance is 50-120 cm.

19. The preparation method according to claim 5, wherein the polymer nanofiber membrane in step (2) has a gram weight of 2-10 g/m², and a nanofiber in the polymer nanofiber membrane has a diameter of 50-900 nm.

20. The preparation method according to claim 5, wherein a hot pressing temperature of the hot pressing treatment in step (4) is lower than the melting point of the polymer nanofiber membrane of the middle layer by 20-60° C., and the pressure of the hot pressing is 500-750 N/cm.
